(19) United States
(12) Patent Application Publication
(10) Pub. No.: US 2013/0339546 A1
(43) Pub. Date: Dec. 19, 2013

(54) DEVICE IDENTIFICATION

(71) Applicants: Sagiv DRAZNIN, Walnut Creek, CA (US); Lalit R. KOTECHA, San Ramon, CA (US); Patricia R. CHANG, San Ramon, CA (US); Thomas W. HAYNES, San Ramon, CA (US); David CHIANG, Fremont, CA (US); John F. MACIAS, Antelope, CA (US); John ANTYPAS, III, Pittsburg, CA (US)

(72) Inventors: Sagiv DRAZNIN, Walnut Creek, CA (US); Lalit R. KOTECHA, San Ramon, CA (US); Patricia R. CHANG, San Ramon, CA (US); Thomas W. HAYNES, San Ramon, CA (US); David CHIANG, Fremont, CA (US); John F. MACIAS, Antelope, CA (US); John ANTYPAS, III, Pittsburg, CA (US)

(73) Assignees: CELLCO PARTNERSHIP D/B/A VERIZON WIRELESS, Basking Ridge, NJ (US); VERIZON PATENT AND LICENSING INC., Basking Ridge, NJ (US)

(21) Appl. No.: 13/495,192

(22) Filed: Jun. 13, 2012

(51) Int. Cl. G06F 15/16

(52) U.S. Cl. 709/245

(57) ABSTRACT

A mobile device is configured to create a network address for the mobile device, the network address allowing the mobile device to communicate across a mobile network; associate the network address with a name for the mobile device; store the network address and the name for the mobile device in a first component, the first component being a part of the mobile device; update the network address, for the mobile device, to a new network address; associate the new network address with the name for the mobile device; store the new network address in the first component; and send, using the first component, the new network address to a first server.

### BACKGROUND

There are a number of devices that are connected through public and private networks. A device may have an Internet Protocol (IP) address and name. The device may communicate with other devices by using its IP address and name. The IP address for the device may change over time.

### BRIEF DESCRIPTION OF DRAWINGS

FIG. 1 is a diagram of an overview of an implementation described herein;

FIGS. 2A-2B are diagrams of example environments in which systems and/or methods described herein may be implemented;

FIG. 3 is a diagram of example components of one or more devices of FIGS. 1 and 2A-2B;

FIG. 4 is a diagram of example functional components of a device in FIGS. 2A-2B;

FIG. 5 is a flow chart of an example process for obtaining an IP address;

FIG. 6 is a flow chart of an example process for obtaining an IP address;

FIG. 7 is a diagram of an example data structure that stores IP addresses;

FIG. 8 is a diagram of an example process for communicating with a device; and

FIG. 9 is a diagram of an example process for communicating with a device.

### DETAILED DESCRIPTION OF PREFERRED EMBODIMENTS

The following detailed description refers to the accompanying drawings. The same reference numbers in different drawings may identify the same or similar elements.

Systems and/or methods described herein may store, forward, and update Internet Protocol (to be referred to as “IP”) addresses from multiple devices. For example, there may be multiple devices located in different geographic areas that may be stationary or mobile. Each device may send IP address and identification information about itself to a server. IP address and identification information for the device may be stored in the server. Each time the device's IP address changes, the device may contact the server, and the server may update the IP address associated with the device's identification that is stored in the server.

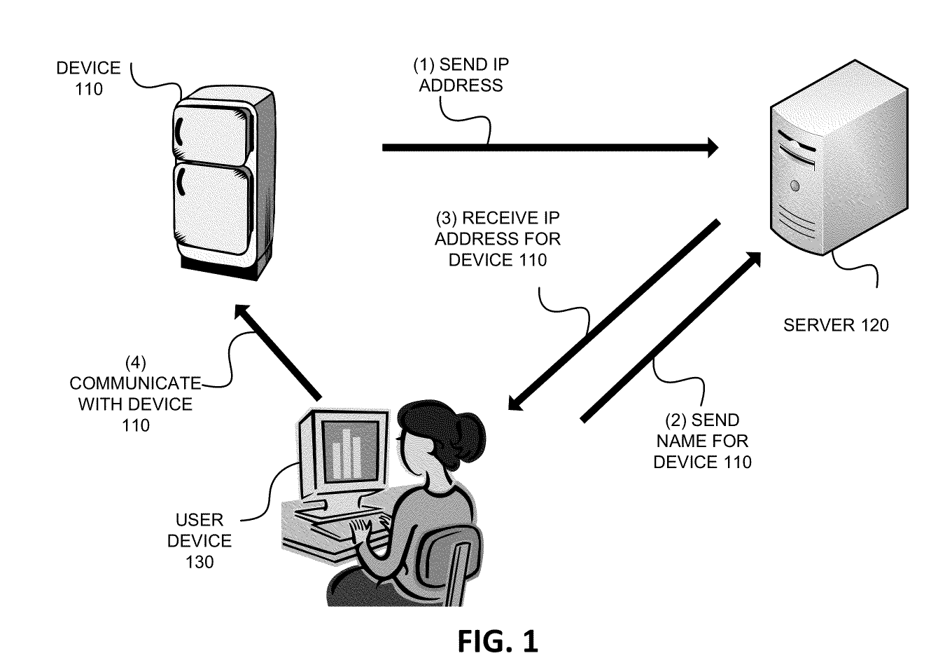

FIG. 1 is a diagram of an overview of an implementation described herein. FIG. 1 shows a device 110, a server 120, and a user device 130. In practice, there may be additional, or fewer, devices, servers, and/or user devices. As shown in FIG. 1, device 110 may communicate its IP address and name to server 120 (shown by communication 1). Server 120 may receive the IP address and name from device 110. Server 120 may store the IP address and name for device 110. Server 120 may store a relationship between the IP address and name for device 110. User device 130 may use the IP address to communicate with device 110.

At some later time, device 110 may change its IP address. Device 110 may forward its new IP address to server 120. Server 120 may update the stored information about device 110 with the new IP address associated with the name for device 110.

To communicate with device 110, user device 130 may send the name for device 110 to server 120 (shown by communication 2). Server 120 may send the IP address to user device 130 (shown by communication 3). User device 130 may communicate with device 110 (shown by communication 4) using the IP address.

As a result, user device 130 may always be able to communicate with device 110 when user device 130 is remotely located from device 110, even though the IP address for device 110 may change over time.

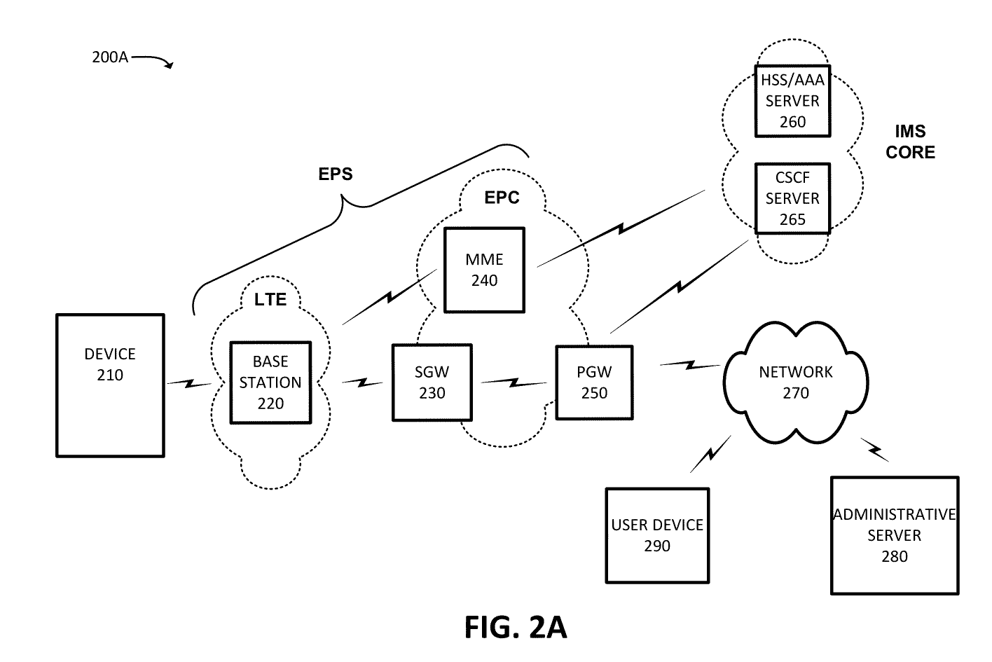

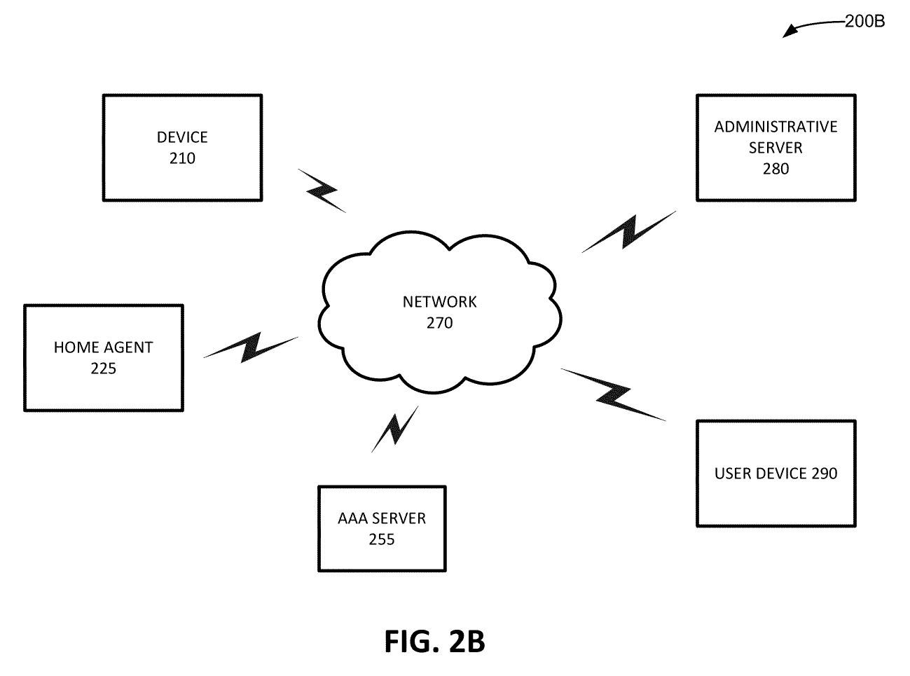

FIG. 2A is a diagram of an example environment 200A in which systems and/or methods described herein may be implemented. As shown in FIG. 2A, environment 200A may include a device 210, a base station 220, a serving gateway 230 (hereinafter referred to as “SGW 230”), a mobility management entity device 240 (hereinafter referred to as “MME 240”), a packet data network (PDN) gateway 250 (hereinafter referred to as “PGW 250”), a home subscriber server (HSS)/authentication, authorization, accounting (AAA) server 260 (hereinafter referred to as “HSS/AAA server 260”), a call session control function (CSCF) server 265 (hereinafter referred to as “CSCF server 265”), a network 270, an administrative server 280, and a user device 290. The quantity of devices, servers, and/or networks, illustrated in FIG. 2A is provided for explanatory purposes only. In practice, there may be additional devices and/or networks; fewer devices and/or networks; different devices and/or networks; and differently arranged devices and/or networks than illustrated in FIG. 2A. Also, in some implementations, one or more of the devices of environment 200A may perform one or more functions described as being performed by another one or more of the devices of environment 200A. Devices of environment 200A may interconnect via wired connections, wireless connections, or a combination of wired and wireless connections.

Environment 200A may include an evolved packet system (EPS) that includes a long term evolution (LTE) network and/or an evolved packet core (EPC) that operate based on a third generation partnership project (3GPP) wireless communication standard. The LTE network may be a radio access network (RAN) that includes one or more base stations, such as eNodeBs (eNBs), via which device 210 communicates with the EPC. The EPC may include SGW 230, MME 240, and/or PGW 250 that enables device 210 to communicate with network 270 and/or an Internet protocol (IP) multimedia subsystem (IMS) core. The IMS core may include HSS/AAA server 260 and/or CSCF server 265 and may manage certain information and services, such as authentication, session initiation, account information, and/or a user profile, associated with device 210. The LTE network may include multiple base stations 220, and the EPC may include multiple SGWs 230, MMEs 240, and/or PGW 250.

Device 210 may include any mechanical, electrical, chemical, mobile, computation, or communication device that is capable of communicating with a network (e.g., network 270). For example, device 210 could correspond to a refrigerator, a utility meter, an air-conditioning unit, a computer, a camera, a personal gaming system, a television, a medical device (e.g., a dialysis machine, a heart rate monitor, a blood pressure monitor, etc.), a vending machine, a dishwasher, an automobile, an engine, a power generator, or any other type of mechanical, electrical, chemical, mobile, computation, or communication device.

In some implementations, device 210 may be associated with a name. The name, for device 210, may be a domain name (e.g., www.device123.com), an alias (e.g., device 123), or any other type of identifier.

In some implementations, device 210 may be associated with an IP address. The IP address may be IP version 4 (IPv4), IP version 6 (IPv6), or any other IP version. The IP address may be a public IP address or a private IP address. While described in terms of an IP address, another type of network address, such as a MAC address, may alternatively be used.

The IP address may require a network address translation of the IP address. The network address translation may modify the IP address information for communications to/from device 210 to other devices over a network. Network address translation may be implemented in network devices that use translation tables to map a private IP address into a public IP address that can traverse a public network (e.g., the Internet). The outgoing public IP address may appear to originate from the network device. Conversely, a public IP address, which is destined for a private network, is translated by a translation table (in a network device) into a private IP address that can traverse a private network.

Base station 220 may include one or more network devices that receive, process, and/or transmit traffic, such as audio, video, text, and/or other data, destined for and/or received from device 210. In an example implementation, base station 220 may be an eNB device and may be part of the LTE network. Base station 220 may receive traffic from and/or send traffic to network 270 via SGW 230 and PGW 250. Base station 220 may send traffic to and/or receive traffic from device 210 via an air interface. One or more of base stations 220 may be associated with a RAN, such as the LTE network.

SGW 230 may include one or more network devices, or other types of computation or communication devices, that gather, process, search, store, and/or provide information in a manner described herein. SGW 230 may include one or more data processing and/or traffic transfer devices, such as a gateway, a router, a modem, a switch, a firewall, a network interface card (NIC), a hub, a bridge, a proxy server, an optical add-drop multiplexer (OADM), or some other type of device that processes and/or transfers traffic. SGW 230 may, for example, aggregate traffic received from one or more base stations 220 and may send the aggregated traffic to network 270 via PGW 250. In one example implementation, SGW 230 may route and forward user data packets, may act as a mobility anchor for a user plane during inter-base station handovers, and may act as an anchor for mobility between LTE and other 3GPP technologies.

MME 240 may include one or more computation or communication devices that gather, process, search, store, and/or provide information in a manner described herein. For example, MME 240 may perform operations associated with a handoff to and/or from the EPS. MME 240 may perform operations to register device 210 with the EPS, to handoff device 210 from the EPS to another network, to handoff a device 210 from the other network to the EPS, and/or to perform other operations. MME 240 may perform policing operations for traffic destined for and/or received from device 210.

PGW 250 may include one or more network devices that gather, process, search, store, and/or provide information in a manner described herein. PGW 250 may include one or more data processing and/or traffic transfer devices, such as a gateway, a router, a modem, a switch, a firewall, a NIC, a hub, a bridge, a proxy server, an OADM, or some other type of device that processes and/or transfers traffic. PGW 250 may, for example, provide connectivity of device 210 to external packet data networks by being a traffic exit/entry point for device 210. PGW 250 may perform policy enforcement, packet filtering, charging support, lawful intercept, and packet screening. PGW 250 may also act as an anchor for mobility between 3GPP and non-3GPP technologies. PGW 250 may authenticate device 210 (e.g., via interaction with HSS/AAA server 260).

HSS/AAA server 260 may include one or more server devices, or other types of computation or communication devices, that gather, process, search, store, and/or provide information in a manner described herein. For example, HSS/AAA server 260 may manage, update, and/or store, in a memory associated with HSS/AAA server 260, profile information associated with device 210 that identifies applications and/or services that are permitted for and/or accessible by device 210, bandwidth or data rate thresholds associated with the applications or services, information associated with a user of device 210 (e.g., a username, a password, a personal identification number (PIN), etc.), rate information, minutes allowed, and/or other information. Additionally, or alternatively, HSS/AAA server 260 may include a device that performs authentication, authorization, and/or accounting (AAA) operations associated with a communication session with device 210.

CSCF server 265 may include one or more server devices, or other types of computation or communication devices, that gather, process, search, store, and/or provide information in a manner described herein. CSCF server 265 may process and/or route calls to and from device 210 via the EPC. For example, CSCF server 265 may process calls, received from network 270, that are destined for device 210. In another example, CSCF server 265 may process calls, received from device 210, that are destined for network 270.

Network 270 may include one or more wired and/or wireless networks. For example, network 270 may include a cellular network, a public land mobile network (PLMN), a second generation (2G) network, a third generation (3G) network, a fourth generation (4G) network, a fifth generation (5G) network, and/or another network. Additionally, or alternatively, network 270 may include a wide area network (WAN), a metropolitan network (MAN), a telephone network (e.g., the Public Switched Telephone Network (PTSSN)), an ad hoc network, an intranet, the Internet, a fiber optic-based network (e.g., FIOS), and/or combination of these or other types of networks.

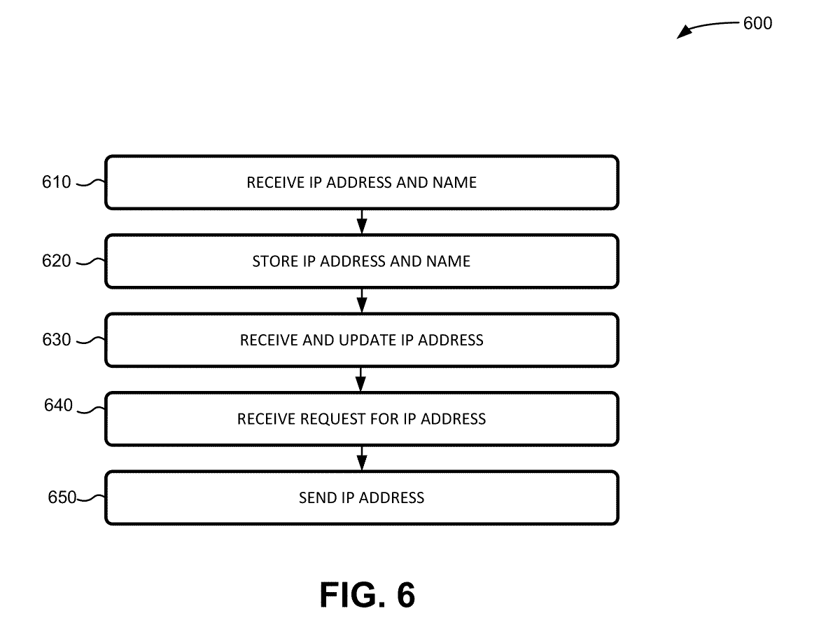

Administrative server 280 may include one or more server devices, or other types of computational or communication devices, that gather, process, search, store, and/or provide information in a manner described herein. Administrative server 280 may be part of network 270, or may be an external device to network 270. In one example implementation, administrative server 280 may be, for example, a presence server (described further with regard to FIG. 6) that may store the IP address and identification information for device 210. In another example implementation, administrative server 280 may be a dynamic domain name system server (hereinafter referred to as “DDNS server”) that acts to translate text-based domain names into numerical IP addresses that are used to route information in networks, such as network 270. In another example implementation, administrative server 280 may be a combination of a DDNS server and a presence server, as described above.

User device 290 may include any computation or communication device, such as a communication device that is capable of communicating with a network (e.g., network 270). For example, user device 290 may include a radiotelephone, a personal communications system (PCS) terminal (e.g., that may combine a cellular radiotelephone with data processing and data communications capabilities), a personal digital assistant (PDA) (e.g., that can include a radiotelephone, a pager, Internet/intranet access, etc.), a smart phone, a computer, a laptop, a tablet computer, a server, a DDNS server, a camera, a personal gaming system, a television, or another mobile, computation, or communication device. In one example implementation, user device 290 may include some, or all, of the features of administrative server 280.

FIG. 2B is a diagram of an example environment 200B in which systems and/or methods described herein may be implemented. As shown in FIG. 2B, environment 200B includes device 210, home agent 225, authentication, authorization, accounting server 255 (hereinafter referred to as “AAA server 255”), network 270, administrative server 280, and user device 290. Device 210, network 270, administrative server 280, and user device 290 are described with regard to FIG. 2A. The quantity of devices, servers and/or networks, illustrated in FIG. 2B is provided for explanatory purposes only. In practice, there may be additional devices and/or networks; fewer devices and/or networks; different devices and/or networks; and differently arranged devices and/or networks than illustrated in FIG. 2B. Also, in some implementations, one or more of the devices of environment 200B may perform one or more functions described as being performed by another one or more of the devices of environment 200B. Devices of environment 200B may interconnect via wired connections, wireless connections, or a combination of wired and wireless connections.

Home agent 225 may include a data transfer device (i.e., a network device), such as a gateway, a router, a switch, a firewall, a network interface card (NIC), a hub, a bridge, a proxy server, an optical add-drop multiplexer (OADM), or some other type of device that processes and/or transfers data. In an example implementation, home agent 225 may include a network device (e.g., on a mobile node's (e.g., device's 210) home network) that tunnels data for delivery to device 210 when device 210 is away from its home network. Home agent 225 may maintain current location (e.g., IP address) information for device 210.

AAA server 255 may include one or more server devices, or other types of computation or communication devices, that gather, process, search, store, and/or provide information in a manner described herein. For example, AAA server 255 may perform authentication, authorization, and/or accounting (AAA) operations associated with a communication session with device 210. With regard to the authentication operation, AAA server 255 may verify a device's (e.g., device 210) specific digital identity provided via an identifier (e.g., a password, a digital certificate, a phone number, etc.) associated with the device. With regard to the authorization function, AAA server 255 may grant or refuse privileges to a device (e.g., device 210) for accessing specific services (e.g., IP address filtering, address assignment, route assignment, quality of service (QoS), etc.). With regard to the accounting operation, AAA server 255 may track consumption of network resources (e.g., by device 210) and may use this information for management, planning, billing, etc.

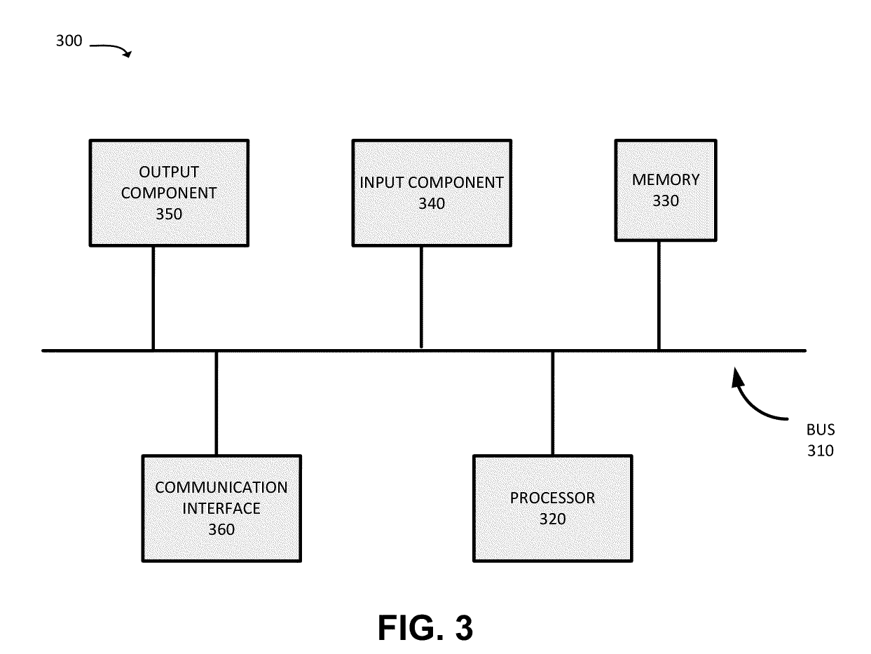

FIG. 3 is a diagram of example components of a device 300. Device 300 may correspond to device 210, base station 220, home agent 225, SGW 230, MME 240, PGW 250, AAA server 255, HSS/AAA server 260, CSCF server 265, administrative server 280, and/or user device 290. Alternatively, or additionally, each of device 210, base station 220, home agent 225, SGW 230, MME 240, PGW 250, AAA server 255, HSS/AAA server 260, CSCF server 265, administrative server 280, and/or user device 290 may include one or more devices 300 and/or one or more components of device 300.

As shown in FIG. 3, device 300 may include a bus 310, a processor 320, a memory 330, an input component 340, an output component 350, and a communication interface 360. In other implementations, device 300 may contain fewer components, additional components, different components, or differently arranged components than depicted in FIG. 3. Additionally, or alternatively, one or more components of device 300 may perform one or more tasks described as being performed by one or more other components of device 300.

Bus 310 may include a path that permits communication among the components of device 300. Processor 320 may include one or more processors, microprocessors, or processing logic that interpret and execute instructions. Memory 330 may include any type of dynamic storage device that stores information and instructions, for execution by processor 320, and/or any type of non-volatile storage device that stores information for use by processor 320.

Input component 340 may include a mechanism that permits a user to input information to device 300, such as a keyboard, a keypad, a button, a switch, etc. Output component 350 may include a mechanism that outputs information to the user, such as a display, a speaker, one or more light emitting diodes (LEDs), etc.

Communication interface 360 may include any transceiver-like mechanism that enables device 300 to communicate with other devices and/or systems. For example, communication interface 360 may include an Ethernet interface, an optical interface, a coaxial interface, a wireless interface, or the like.

In another implementation, communication interface 360 may include, for example, a transmitter that may convert baseband signals from processor 320 to radio frequency (RF) signals and/or a receiver that may convert RF signals to baseband signals. Alternatively, communication interface 360 may include a transceiver to perform functions of both a transmitter and a receiver of wireless communications (e.g., radio frequency, infrared, visual optics, etc.), wired communications (e.g., conductive wire, twisted pair cable, coaxial cable, transmission line, fiber optic cable, waveguide, etc.), or a combination of wireless and wired communications. Communication interface 360 may connect to an antenna assembly (not shown in FIG. 3) for transmission and/or reception of the RF signals.

The antenna assembly may include one or more antennas to transmit and/or receive RF signals over the air. The antenna assembly may, for example, receive RF signals from communication interface 360 and transmit the RF signals over the air, and receive RF signals over the air and provide the RF signals to communication interface 360. In one implementation, for example, communication interface 360 may communicate with network 270 and/or devices connected to network 270.

As will be described in detail below, device 300 may perform certain operations. Device 300 may perform these operations in response to processor 320 executing software instructions (e.g., computer program(s)) contained in a computer-readable medium, such as memory 330, a secondary storage device (e.g., hard disk, CD-ROM, etc.), or other forms of RAM or ROM. A computer-readable medium may be defined as a non-transitory memory device. A memory device may include space within a single physical memory device or spread across multiple physical memory devices. The software instructions may be read into memory 330 from another computer-readable medium or from another device. The software instructions contained in memory 330 may cause processor 320 to perform processes described herein. Alternatively, hardwired circuitry may be used in place of or in combination with software instructions to implement processes described herein. Thus, implementations described herein are not limited to any specific combination of hardware circuitry and software.

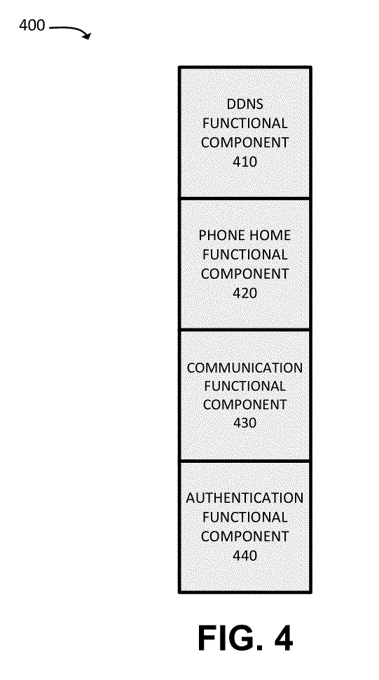

FIG. 4 is a diagram of example functional components of device 210. As shown in FIG. 4, device 210 may include DDNS functional component 410, phone home functional component 420, communication functional component 430, and/or authentication functional component 440. The number of functional components illustrated in FIG. 4 is provided for simplicity, and device 210 may include additional, fewer, and/or different functional components than illustrated in FIG. 4. One or more functional components illustrated in FIG. 4 may perform one or more tasks described as being performed by one or more functional components of FIG. 4. In one implementation, the functions described in connection with FIG. 4 may be performed by one or more components of device 300 (FIG. 3) or by one or more devices 300.

DDNS functional component 410 may store an IP address and a name for device 210. In the situation where administrative server 280 corresponds to a DDNS server, DDNS functional component 410 may send the IP address and name to administrative server 280 each time the IP address for device 210 changes.

Phone home functional component 420 may store an IP address and a name for device 210. In the situation where administrative server 280 corresponds to a presence server, phone home functional component 420 may send the IP address and name to administrative server 280, at the expiration of intervals of time. For example, phone home functional component 420 may communicate with administrative server 280 every hour, every 12 hours, or once a month.

DDNS functional component 410 and phone home functional component 420 may both operate at the same time. Alternatively, one of DDNS functional component 410 or phone home functional component 420 may operate at a given time. The programming of device 210 may control whether one or both of DDNS functional component 410 or phone home functional component 420 operates at a given time.

Communication functional component 430 may handle communications for device 210. This may include, for example, radio functions (e.g., a base-band processor), such as radio control confirmations (signal modulation, encoding, and/or radio-frequency shifting), and/or radio reliability. Additionally, or alternatively, this may include modulating (e.g., a modem, such as an LTE modem) an analog carrier signal to encode digital information, and demodulating a carrier signal to decode the transmitted information.

Authentication functional component 440 may perform the function of authenticating communications to/from device 210. This may include, for example, the functions of storing security protocols (e.g., on a universal integrated circuit card—“UICC”) that may allow device 210 to access networks, such as network 270, and/or any LTE-EPC-IMS Core system, described with regard to FIG. 2A.

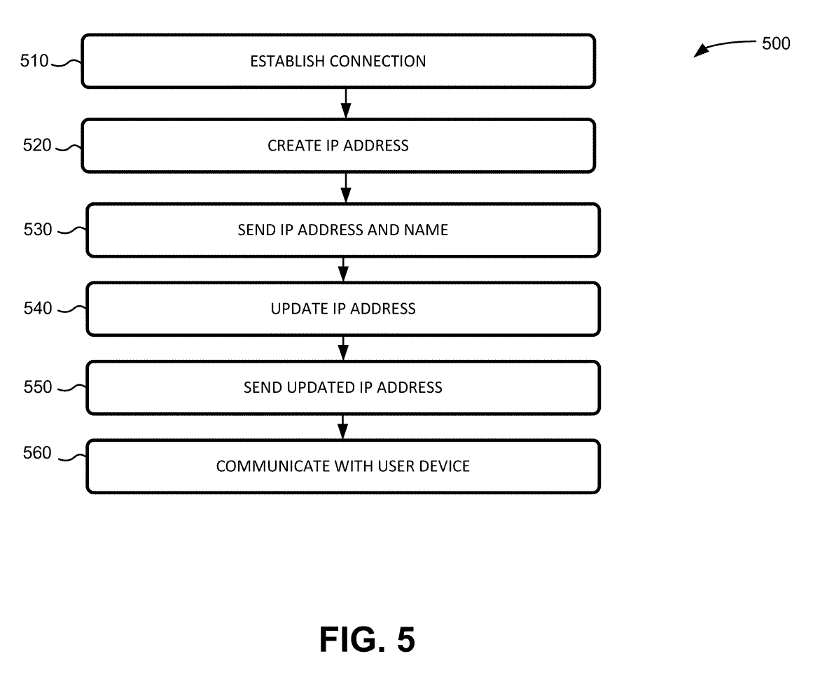

FIG. 5 is a flow chart of an example process 500 for obtaining an IP address. In one implementation, process 500 may be performed by device 210. In another implementation, one or more blocks of process 500 may be performed by one or more other devices, such as administrative server 280 and/or user device 290.

Process 500 may include establishing a connection with a network (block 510). For example, device 210 may establish a connection with network 270. In one example implementation, device 210 may send a request to network 270, to establish a connection to network 270. The request may be accepted and device 210 may establish a connection to network 270.

In another example implementation, device 210 may communicate with PGW 250 (via base station 220 and SGW 250, described with regard to FIG. 2A). PGW 250 may forward information about device 210 to HSS/AAA server 260 to authenticate and authorize device 210. HSS/AAA server 260 may authenticate device 210 and communicate with PGW 250 that device 210 has been authenticated. PGW 250 may register device 210 and allow device 210 to establish a connection to network 270.

Process 500 may include creating an IP address for the device (block 520). For example, an IP address may be created for device 210. Device 210 may assign, or randomly choose, part of the IP address (e.g., the lower 16 bits, 32 bits, or 64 bits of the IP address) for device 210. The remaining part of the IP address for device 210 may be created using identification information for network 270. The identification information for network 270 may include any alpha/numeric combination and/or code associated with network 270.

DDNS functional component 410 (in device 210) may store the IP address and the name in device 210. Additionally, or alternatively, phone home functional component 420 (in device 210) may store the IP address and name in device 210. Additionally, or alternatively, the IP address and name for device 210 may be stored by a component, in device 210, other than DDNS functional component 410 and phone home functional component 420.

Process 500 may include sending the IP address and name (block 530). For example, device 210 may send the IP address and name to administrative server 280. Device 210 may execute DDNS functional component 410 (described with regard to FIG. 4) to communicate the name and IP address (for device 210) to administrative server 280. Additionally, or alternatively, device 210 may execute phone home functional component 420 (described with regard to FIG. 4) to communicate with administrative server 280.

In one example implementation, device 210 may send the IP address and name for device 210 to administrative server 280, via PGW 250. PGW 250 may receive the IP address and name for device 210. PGW 250 may communicate with HSS/AAA server 260, so that HSS/AAA server 260 may authenticate device 210. HSS/AAA server 260 may communicate to PGW 250 that device 210 has been authenticated. PGW 250 may send the IP address and name, via network 270, to administrative server 280 when device 210 has been authenticated.

In another example implementation, device 210 may send the IP address and name for device 210 to administrative server 280, via home agent 225 and AAA server 255. Home agent 225 may receive the IP address and name. Home agent 225 may forward the IP address and name to AAA server 255. AAA server 255 may authenticate device 210. AAA server 255 may send the IP address and name to administrative server 280 when device 210 has been authenticated.

In another example implementation, device 210 may send the IP address and name for device 210 to administrative server 280, via home agent 225. Home agent 225 may receive the IP address and name for device 210. Home agent 225 may forward the IP address and name to administrative server 280.

Process 500 may include updating the IP address for the device (block 540). For example, the IP address for device 210 may change due to a change in the location of device 210; a change in the network that device 210 is connected to; and/or any other reason that would cause the IP address for device 210 to change. Upon a change to the IP address for device 210, DDNS functional component 410 (in device 210) may update the stored IP address in DDNS functional component 410 with the updated IP address for device 210. Additionally, or alternatively, phone home functional component 420 (in device 210) may update the stored IP address in phone home functional component 420 with the updated IP address for device 210.

Additionally, or alternatively, another component (in device 210), other than DDNS functional component 410 and phone home functional component 420, may update the stored IP address with the new IP address for device 210.

Process 500 may include sending the updated IP address (block 550). For example, DDNS functional component 410 (in device 210) may send the updated IP address to administrative server 280 (when administrative server 280 takes the form of a DDNS server), similar to the process described with regard to block 530 in FIG. 5. Additionally, or alternatively, phone home functional component 420 (in device 210) may send the updated IP address to administrative server 280 (when administrative server 280 takes the form of a presence server), similar to the process described with regard to block 530 in FIG. 5.

Process 500 may include communicating with the user device (block 560). The user, of user device 290, may, for example, want to obtain energy consumption information from a smart meter (device 210). User device 290 may send the name, for device 210, to administrative server 280. Administrative server 280 may receive the name for device 210. Administrative server 280 may find the IP address, for device 210, via a lookup, using the name that was provided by user device 290. Administrative server 280 may send the IP address to user device 290. User device 290 may use the IP address to communicate with device 210. Once user device 290 has contacted device 210, user device 290 may retrieve the information (e.g., energy consumption) desired by the user of user device 290.

FIG. 6 is a flow chart of an example process 600 for obtaining an IP address. In one implementation, process 600 may be performed by administrative server 280. In another implementation, one or more blocks of process 600 may be performed by device 210 and/or user device 290.

Process 600 may include receiving an IP address and name from a device (block 610). For example, device 210 may have created an IP address in a process similar to that described with regard to block 520 for FIG. 5. Administrative server 280 may receive, from device 210, the IP address and name for device 210, in a manner similar to that described with regard to block 530 in FIG. 5.

Process 600 may include storing the IP address and name for the device (block 620). For example, administrative server 280 may store the name and IP address for device 210.

In one example implementation, administrative server 280 may be configured as a presence server. Administrative server 280 may receive the IP address and name for device 210. Administrative server 280 may store the IP address and name information for device 210 according to policy rules stored in the administrative server 280.

Policy rules may be used to assign the IP address and name for device 210 within administrative server 280. The policy rules may include rules about the designation of the IP address and name of device 210 within the presence server; host name requirements; information about the range for the IP pool parameters; designation of the IP address and name based on a port specified for device 210; and accessibility to the IP address and name information within the presence server. Additionally, policy rules may be used to allocate devices 210 based upon the mobile-access point name (to be referred to as “M-APN”). The M-APN may describe a network with which device 210 is connected. For example, the M-APN may be associated with network 270 which may be a private network, a public network, and/or an LTE network, or any other network, described with regard to FIGS. 2A-2B.

There may be different policy rules for different devices 210. For example, administrative server 280 (e.g., a presence server) may store IP address and name for devices 210 for company A (e.g., a car manufacturer) and the IP address and name for company B (e.g., a utility company). Company A may have different policy rules than the policy rules for company B about how the IP address and name of device 210 may be stored in administrative server 280 and how the IP address may be accessed by user device 290.

In another example implementation, administrative server 280 may be configured as a DDNS server (described with regard to FIG. 2A). Administrative server 280 may receive the IP address and name for device 210, via network 270. Administrative server 280 may store the name and IP address for device 210.

Process 600 may include receiving an updated IP address for the device (block 630). For example, if the IP address of device 210 changes, device 210 may send the updated IP address to administrative server 280. Administrative server 280 may receive an updated IP address for device 210, as described with regard to block 550 in FIG. 5. Administrative server 280 may update the IP address, for device 210, in administrative server 280.

In one example implementation, administrative server 280 may be configured as a presence server. Administrative server 280 may receive and store the updated IP address for device 210 using policy rules, described with regard to block 620 in FIG. 6. In another example implementation, administrative server 280 may be configured a DDNS server. Administrative server 280 may receive and store the updated IP address for device 210, in a manner similar to that described with regard to block 620 in FIG. 6.

Process 600 may include receiving a request for the IP address (block 640). For example, administrative server 280 may receive, from user device 290, a request for the IP address for device 210. User device 290 may have the name (e.g., www.device123.com) for device 210. User device 290 may communicate the name for device 210 to administrative server 280. Using the name for device 210, administrative server 280 may find the IP address for device 210.

Process 600 may include sending the IP address (block 650). Administrative server 280 may send the IP address (for device 210), via network 270, to user device 290. With the IP address for device 210, user device 290 may communicate with device 210.

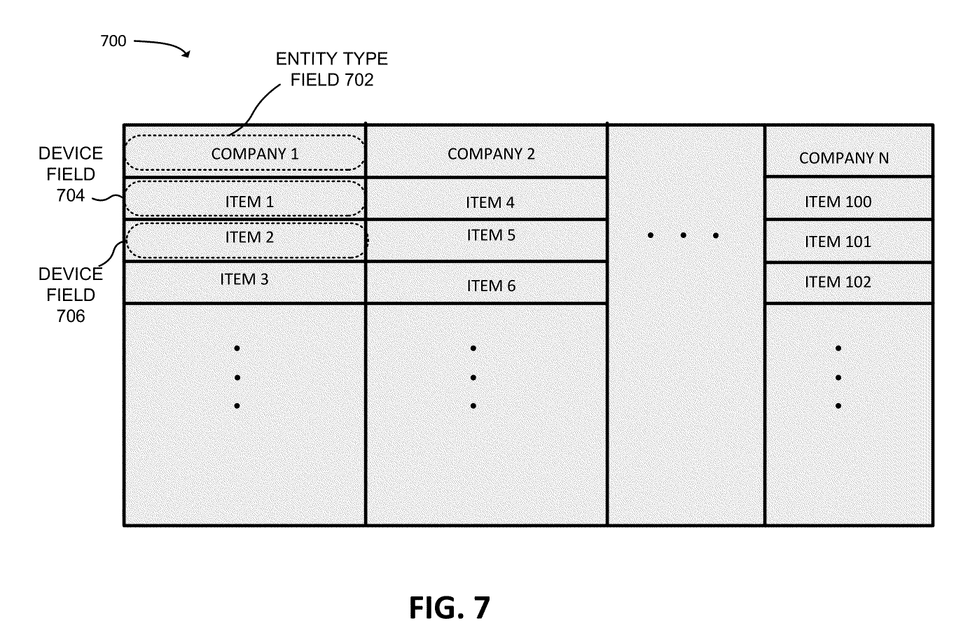

FIG. 7 is a diagram of an example data structure 700 that stores information about IP address and name information for device 210. In one example implementation, administrative server 280 may store data structure 700. Additionally, or alternatively, user device 290 and/or device 210 may store data structure 700. Additionally, or alternatively, data structure 700 may be stored in memory, associated with another device or a group of devices, separate from or in combination with the memory associated with administrative server 280, user device 290 and/or device 210.

Data structure 700 may include a collection of fields, such as an entity type field 702, device field 704, and device field 706. Although FIG. 7 shows example fields 702-706, in other implementations, data structure 700 may include fewer fields, different fields, additional fields, and/or differently arranged fields than depicted in FIG. 7. Additionally, or alternatively, one or more fields of data structure 700 may include information described as being included in one or more other fields of data structure 700.

Entity type field 702 may store information about a particular entity that is associated with device 210. For example the entity could be a company, a party, or an individual. For example, a particular company could be an electric utility, a car manufacturer or service company, an appliance manufacturer, a service and repair company, or the like.

Device field 704 and/or device field 706 may store information about a particular device 210. For example, device field 704 may store an IP address associated with device 210 and/or a name associated with device 210. Item 2, in device field 706, may, for example, include another IP address for another device 210 associated with the same company.

In one example implementation, administrative server 280 may receive an IP address and name for device 210. Administrative server 280, when functioning as a presence server (described with regard to FIG. 2A), may assign the IP address and name into device field 704. User device 290 may send the name, for device 210, to administrative server 280. Administrative server 280 may search for the name, given by user device 290, and find the name in device field 704. Administrative server 280 may then find the IP address that is associated with the name in device field 704. Administrative server 280 may send the IP address to user device 290. User device 290 may communicate with device 210, based on the IP address for device 210 (in device field 704).

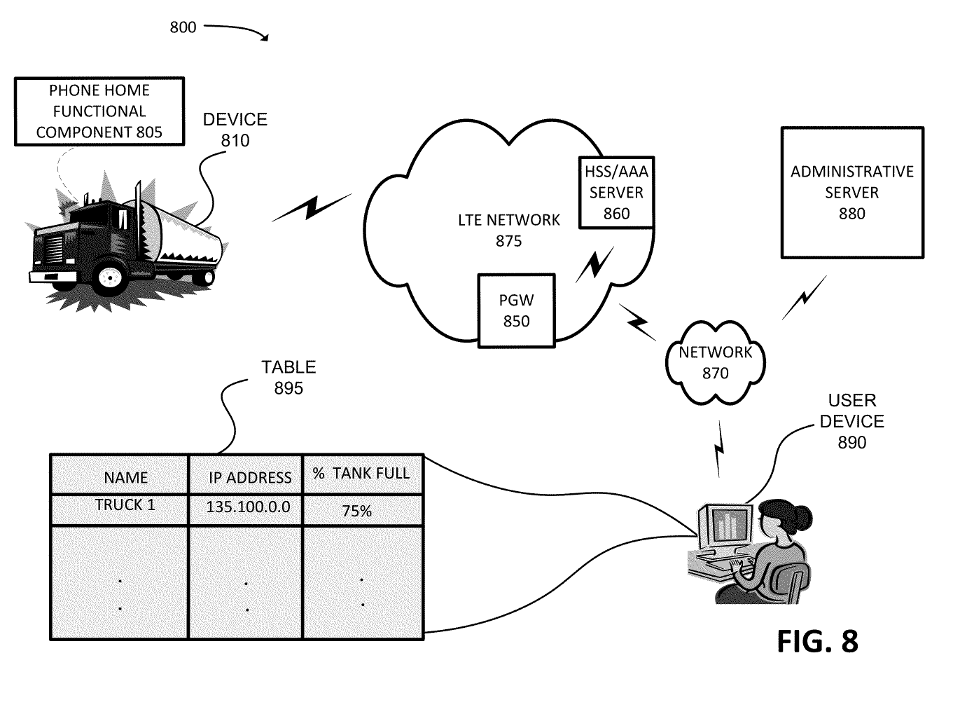

FIG. 8 is a diagram of example process 800 for communicating with a device. FIG. 8 shows phone home functional component 805, device 810, PGW 850, HSS/AAA server 860, network 870, LTE network 875, administrative server 880, user device 890, and table 895.

An example of phone home functional component 805 may correspond to phone home functional component 420, described with regard to FIG. 4. An example of device 810 may correspond to device 210, described with regard to FIGS. 2A-2B. An example of PGW 850 may correspond to PGW 250, described with regard to FIG. 2A. An example of HSS/AAA server 860 may correspond to HSS/AAA server 260 described with regard to FIG. 2A. An example of network 870 may correspond to network 270, described with regard to FIGS. 2A-2B. An example of LTE network 875 may correspond to one or more of the devices (base station 220, SGW 230, MME 240, and CSCF server 265) that make up the LTE, EPC and/or IMS Core, described with regard to FIG. 2A. An example of administrative server 880 may correspond to administrative server 280, described with regard to FIGS. 2A-2B. An example of user device 890 may correspond to user device 290, described with regard to FIGS. 2A-2B.

In FIG. 8, assume that a user, of user device 890, is looking to obtain information about device 810. Assume that device 810 is located remotely from user device 890. Assume that both device 810 and user device 890 have established a connection to network 870 and LTE network 875. Assume that device 810 has created an IP address. Assume that administrative server 880 is configured as a presence server.

As shown in FIG. 8, device 810 is a tanker truck. Assume that the driver of the tanker truck is called Fred. Fred is at a truck stop in Lauderhill and is on his way to make a delivery of fuel to a gas station in North Miami Beach. At that time, at the truck stop, the tanker truck is 75% full. Fred decides to take 1-95 from Lauderhill to North Miami Beach. The tanker truck is owned by the same company that employs Fred. Assume that the company is called Trico Fuels.

Trico Fuels, located in Dallas, wants to know, at any given time, the amount of fuel in all of the tanker trucks in its North American fleet. Assume that user device 890 is a computer owned by Trico Fuels, and that the user, of user device 890, is an analyst (called Mary) who works for Trico Fuels. Mary is responsible for making sure that the fuel in the tanker truck is delivered in the correct quantities to the customers (gas stations) of Trico Fuels. Mary may have an application operating on user device 890 that allows user device 890 to communicate with administrative server 880 and with device 810.

As Fred starts his journey to North Miami Beach, at 8:00 a.m., phone home functional component 805 sends the IP address and name for the tanker truck to administrative server 880, described with regard to block 530 in FIG. 5. The IP address and name are sent and stored in administrative server 880 that is configured as a presence server, described with regard to block 620 in FIG. 6. Assume that administrative server 880 is owned by VZ Services. Trico Fuels has contracted with VZ Services to provide the services for maintaining contact with Trico Fuels' tanker trucks.

At 8:00 a.m., Mary has not yet arrived at work and has not yet turned on her computer to find the status of the tanker truck driven by Fred.

Phone home functional component 805 is configured to provide an update to the IP address of the tanker truck every time the IP address changes. At 8:30 AM, the IP address for the tanker truck has changed. The updated IP address, for the tanker truck, is sent to administrative server 880. Administrative server 880 receives (via PGW 850 and HSS/AAA server 860) and stores the updated IP address, described with regard to block 630 in FIG. 6.

At 8:40 a.m., Mary has turned on her computer (user device 890) and is now looking for tanker trucks currently assigned to Florida. Mary has on her screen, “truck 1” which is the name given to the tanker truck being driven by Fred.

When Mary selects “truck 1” on her computer screen, a communication is made between user device 890 and administrative server 880. User device 290 sends the name (e.g., www.truck1trico.com) for “truck1” to administrative server 880. Administrative server 880 searches for “truck 1” which is assigned to Trico Fuels. Administrative server 880 may find the IP address for “truck 1” (e.g., 135.100.0.0) and communicate the IP address for “truck 1” to user device 890. User device 890 may receive the IP address for “truck 1.” With the IP address for “truck 1,” Mary may now contact “truck 1” (the tanker truck driven by Fred) and obtain the percentage full value of the fuel storage tank.

As shown in table 895, Mary may view the name of a tanker truck (device 810), the IP address for the tanker truck, and the percentage (%) tank fuel for the tanker truck.

While FIG. 8 describes administrative server 880 as a presence server, administrative 880 could also be configured as a DDNS server. In the situation where administrative server 880 is a DDNS server, DDNS functional component 410 may send the IP address and name for device 810 to the DDNS server.

While FIG. 8 describes a phone home functional component 805, device 810 may also include a DDNS functional component 410 functioning at the same time and sending updates to administrative server 880 or another administrator server 880 configured as a DDNS server.

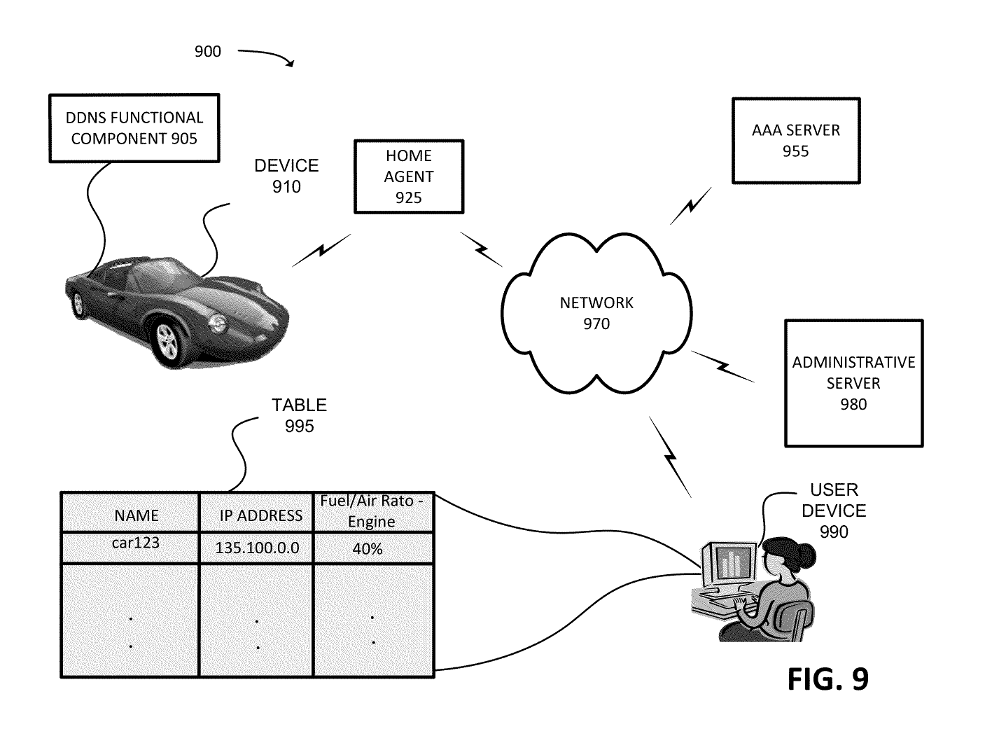

FIG. 9 is a diagram of example process 900 for communicating with a device. FIG. 9 shows a DDNS functional component 905, device 910, home agent 925, AAA server 955, network 970, administrative server 980, user device 990, and table 995.

An example of DDNS functional component 905 may correspond to DDNS functional component 410, described with regard to FIG. 4. An example of device 910 may correspond to device 210, described with regard to FIGS. 2A-2B. An example of home agent 925 may correspond to home agent 225, described with to regard to FIGS. 2A-2B. An example of AAA server 955 may correspond to AAA server 255, described with regard to FIGS. 2A-2B. An example of network 970 may correspond to network 270, described with regard to FIGS. 2A-2B. An example of administrative server 980 may correspond to administrative server 280, described with regard to FIGS. 2A-2B. An example of user device 990 may correspond to user device 290, described with regard to FIGS. 2A-2B.

In FIG. 9, a user, of user device 990, is looking to obtain information about device 910. Assume that device 910 is located remotely from user device 990. Assume that both device 910 and user device 990 have established connections to network 870. Assume that device 910 has created an IP address. Assume that administrative server 980 is configured as a DDNS server.

As shown in FIG. 9, device 910 is car. Assume that the user, of the car, is called Bob. Bob likes to take his car for a long drive on the Pacific Highway every Sunday morning. Bob's car was manufactured by TEKO. TEKO provides a 3 year warranty on the car. TEKO uses information about the car's usage to determine future strategies on how to promote the quality of their product's engines.

At 9:00 a.m., Bob is on the Pacific Highway near San Francisco. At that time, DDNS functional component 905 sends the IP address and name for device 910, via home agent 925, AAA server 955 and network 970, to administrative server 980, described with regard to block 530, in FIG. 5. Administrative server 980 stores the IP address and name (e.g., domain name) for the car. Assume that administrative server 980 is owned and operated by TEKO.

At 9:30 a.m., Bob is still on the Pacific Highway, just south of South Francisco. At that time, the IP address for the car may change. DDNS functional component 905 communicates the updated IP address to administrative server 980. Administrative server 980 now has the updated IP address associated with the name for the car.

Assume that the user, of user device 990, is called Jane. Assume that Jane is in Los Angeles. At 9:31 a.m., Jane decides to run a report on cars that are the same model as the car owned by Bob. Jane may have an application operating on user device 990 that allows user device 990 to communicate with administrative server 980 and with device 910. Jane decides that the report should include information about the current fuel/air ratio for gasoline intake into the car's engine.

Jane has an alias for each car that is associated with a domain name for each car. Thus, for Bob's car, Jane has an alias of car123 that is associated with a domain name www.car123.com. Upon Jane's request to view information about Bob's car, user device 990 sends the domain name for Bob's car to administrative server 980. Administrative server 980 receives the domain name and looks up the current IP address for Bob's car. Administrative server 980 may find the IP address for Bob's car and send the IP address to user device 990. Using the IP address, user device 990 may contact Bob's car and obtain the fuel/air ratio value for the engine in Bob's car.

While FIG. 9 describes administrative server 980 as a DDNS server, administrative 880 could also be configured as a presence server. In the situation that administrative server 880 is a presence server, phone functional component 420 may send the IP address and name for device 810 to the presence server.

While FIG. 9 describes a DDNS functional component 905, device 910 may also include a phone home functional component 420 functioning at the same time and sending updates to administrative server 980 or another administrator server 980 configured as a presence server.

The foregoing description of implementations provides illustration and description, but is not intended to be exhaustive or to limit the implementations to the precise form disclosed. Modifications and variations are possible in light of the above disclosure or may be acquired from practice of the implementations.

While series of blocks have been described with regard to FIGS. 5 and 6, the order of the blocks may be modified in other implementations. Further, non-dependent blocks may be performed in parallel.

It will be apparent that example aspects, as described above, may be implemented in many different forms of software, firmware, and hardware in the implementations illustrated in the figures. The actual software code or specialized control hardware used to implement these aspects should not be construed as limiting. Thus, the operation and behavior of the aspects were described without reference to the specific software code—it being understood that software and control hardware could be designed to implement the aspects based on the description herein.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

No element, act, or instruction used in the present application should be construed as critical or essential unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method comprising:
creating, by a mobile device, a network address for the mobile device, the network address allowing the mobile device to communicate across a mobile network;
associating, by the mobile device, the network address with a name for the mobile device;
storing, by the mobile device, the network address and the name for the mobile device in a first component, the first component being a part of the mobile device;
updating, by the mobile device, the network address, for the mobile device, to a new network address;
associating, by the mobile device, the new network address with the name for the mobile device;
storing, by the mobile device, the new network address in the first component; and
sending, by the mobile device, using the first component, the new network address to a first server.

2. The method of claim 1, where the first component is a DDNS component and the first server is a DDNS server.

3. The method of claim 1, further comprising:
storing, by the mobile device, the new network address and the name for the mobile device in a second component, the second component being a part of the mobile device and being a separate component than the first component; and
sending, by the mobile device, and using the second component, the new network address to a second server.

4. The method of claim 3, where the second component is a phone home component and the second server is a presence server.

5. The method of claim 3, where sending the new network address to the second server includes:
determining that an interval of time has expired; and
sending the new network address to the second server based on determining that the interval of time has expired.

6. The method of claim 3, where the first component and the second component, in the mobile device, operate at the same time.

7. The method of claim 3, where one of the first component or the second component, in the mobile device, operate at one time.

8. A system comprising:
a mobile device to:
create a network address for the mobile device, the network address allowing the mobile device to communicate across a mobile network;
associate the network address with a name for the mobile device;
store the network address and the name for the mobile device in a first component, the first component being a part of the mobile device;
update the network address, for the mobile device, to a new network address;
associate the new network address with the name for the mobile device;
store the new network address in the first component; and
send the new network address to a first server, to permit a user device to obtain the new network address, from the first server, based on the name for the mobile device.

9. The system of claim 8, where the mobile device is to:
store the new network address and the name for the mobile device in a second component, the second component being a part of the mobile device and being a separate component than the first component; and
send, using the second component, the new network address to a second server.

10. The system of claim 9, where, when sending the new network address to the second server, the mobile device is further to:
determine that an interval of time has expired, and sending the new network address to the second server based on determining that the interval of time has expired.

11. The system of claim 9, where the first component and the second component operate at the same time.

12. The system of claim 9, where one of the first component or the second component is to operate at one time.

13. A computer-readable medium, comprising:
one or more instructions that, when executed by one or more processors of a mobile device, cause the one or more processors to:
create a network address for the mobile device, the network address allowing the mobile device to communicate across a network;
associate the network address with a name for the mobile device;
store the network address and the name for the mobile device in a first component, the first component being a part of the mobile device;
update the network address, for the mobile device, to a new network address;
associate the new network address with the name for the mobile device;
store the new network address in the first component;
send the new network address to a first server; and
receive a request for information from a user device that received the new network address from the first server, and communicated with the mobile device with the new network address.

14. The computer-readable medium of claim 13, further comprising:
one or more instructions that, when executed by the one or more processors, cause the one or more processors to:
store the new network address and the name for the mobile device in a second component, the second component being a part of the mobile device and being a separate component than the first component; and
send, using the second component, the new network address to a second server.

15. The computer-readable medium of claim 14, where the second component is a DDNS component and the second server is a DDNS server.

16. The computer-readable medium of claim 14, where one of the first component or the second component operates at one time.

17. The computer-readable medium of claim 13, where the network address is a private network address.

18. A method comprising:
receiving, by a server, a first name and a first network address for a first mobile device;
receiving, by the server, a second name and a second network address for a second mobile device;
storing, by the server, the first name and the first network address for the first mobile device in a first specified storage portion of memory associated with a first entity;
storing, by the server, the second name and the second network address for the second mobile device in a second specified storage portion of memory associated with a second entity;
receiving, by the server, a first request from a first user device, the first request including the first name of the first mobile device;
sending, by the server, the first network address to the first user device;
receiving, by the server, a second request from a second user device, the second request including the second name of the second mobile device; and
sending, by the server, the second network address to the second user device.

19. The method of claim 18, where first entity and the second entity are different entities.

20. The method of claim 18, where the first network address is a public network address and the second network address is a private network address.
